(19) United States
(12) Patent Application Publication
(10) Pub. No.: US 2026/0178909 A1
(43) Pub. Date: Jun. 25, 2026

(54) METHOD AND SYSTEM FOR OPTIMIZING DEEP LEARNING MODEL USING EDGE-BASED PARTITION AND PARALLEL COMPILATION

(71) Applicant: MEDIATEK INC., Hsinchu City (TW)

(72) Inventors: Yu-Sheng Hsieh, Hsinchu City (TW); Ming-Yu Hung, Hsinchu City (TW); Wei-Liang Kuo, Hsinchu City (TW)

(73) Assignee: MEDIATEK INC., Hsinchu City (TW)

(21) Appl. No.: 18/991,661

(22) Filed: Dec. 22, 2024

(51) Int. Cl. G06N 3/082; G06N 3/045

(52) U.S. Cl. CPC G06N 3/082; G06N 3/045

(57) ABSTRACT

A method for optimizing a deep learning model includes: providing a computational graph representation of the deep learning model; determining sub-model boundaries of a plurality of sub-models corresponding to the deep learning model, based on at least memory traffic costs respectively associated with a plurality of edges in the computational graph of the deep learning model; respectively generating the plurality of sub-models based on the determined sub-model boundaries; and separately performing compilation operations on the plurality of sub-models to generate a plurality of compilation results.

### BACKGROUND

The present invention relates to deep learning, and more particularly, to method and system for optimizing deep learning model using edge-based partition and parallel compilation.

The field of deep learning has witnessed unprecedented

growth in recent years, with models expanding in both size and complexity. While this growth has facilitated remarkable advancements across various domains, it has also introduced significant challenges in model compilation and optimization. As deep learning models continue to evolve, two critical issues have emerged as particularly pressing in their landscape: extended compilation times for large-scale models and inefficiencies in traditional model partitioning methods.

The compilation process for large models has become a substantial bottleneck in the development, often extending to several days or even weeks. This issue is notably pronounced in the context of auto-tuning, a crucial process for optimizing model performance across different hardware configurations. Such prolonged compilation times not only impede the iterative development process but also significantly delay the deployment of these models in real-world applications. This challenge affects the efficiency of research and development cycles and hinders the timely adaptation of models to evolving data and requirements.

On the other hand, existing approaches to model partitioning, while addressing some aspects of the compilation challenge, often fall short in fully considering memory traffic. This results in the creation of sub-graphs within the model that exhibit poor performance in model compilation, particularly in memory-constrained hardware environments.

### SUMMARY

The present invention introduces an innovative approach to address the significant challenges faced in compiling and optimizing large-scale deep learning models. At its core, the present invention proposes a method that leverages edge-based graph partitioning techniques to efficiently decompose complex neural networks of deep learning models into partitioned sub-models. Such decomposition is achieved through a comprehensive analysis of a computational graph of the deep learning model, focusing on memory traffic costs and aligning partitioned sub-models with capabilities of target compilers. Subsequently, the present invention capitalizes on partitioned sub-models by implementing a parallel compilation strategy. The parallel compilation significantly enhances compilation efficiency. By synergistically combining edge-based partition algorithms with parallel compilation, the present invention offers a comprehensive solution that potentially reduces compilation times and optimizes memory utilization.

According to one embodiment, a method for optimizing a deep learning model is provided. The method comprises: providing a computational graph representation of the deep learning model; determining sub-model boundaries of a plurality of sub-models corresponding to the deep learning model, based on at least memory traffic costs respectively associated with a plurality of edges in the computational graph of the deep learning model; respectively generating the plurality of sub-models based on the determined sub-model boundaries; and separately performing compilation operations on the plurality of sub-models to generate a plurality of compilation results.

According to one embodiment, a system for optimizing deep learning models is provided. The system comprises: a processor and a memory storing instructions. When the instructions are executed by the processor, the system is caused to perform operations comprising: providing a computational graph representation of the deep learning model; determining sub-model boundaries of a plurality of sub-models corresponding to the deep learning model, based on at least memory traffic costs respectively associated with a plurality of edges in the computational graph of the deep learning model; respectively generating the plurality of sub-models based on the determined sub-model boundaries; and separately performing compilation operations on the plurality of sub-models to generate a plurality of compilation results.

According to one embodiment, a non-transitory computer-readable storage medium storing instructions is provided. When the instructions are executed by a processor, the processor is caused to perform operations of: providing a computational graph representation of the deep learning model; determining sub-model boundaries of a plurality of sub-models corresponding to the deep learning model, based on at least memory traffic costs respectively associated with a plurality of edges in the computational graph of the deep learning model; respectively generating the plurality of sub-models based on the determined sub-model boundaries; and separately performing compilation operations on the plurality of sub-models to generate a plurality of compilation results.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a system of optimizing a deep learning model according to one embodiment of the present invention.

FIG. 2 illustrates a possible hardware implementation of a system of optimizing a deep learning model according to one embodiment of the present invention.

FIG. 3 illustrates a flow chart of a method of optimizing a deep learning model according to one embodiment of the present invention.

FIG. 4 illustrates a portion of a computational graph of a deep learning model.

FIG. 5 illustrates a flow chart of a method of optimizing a deep learning model according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

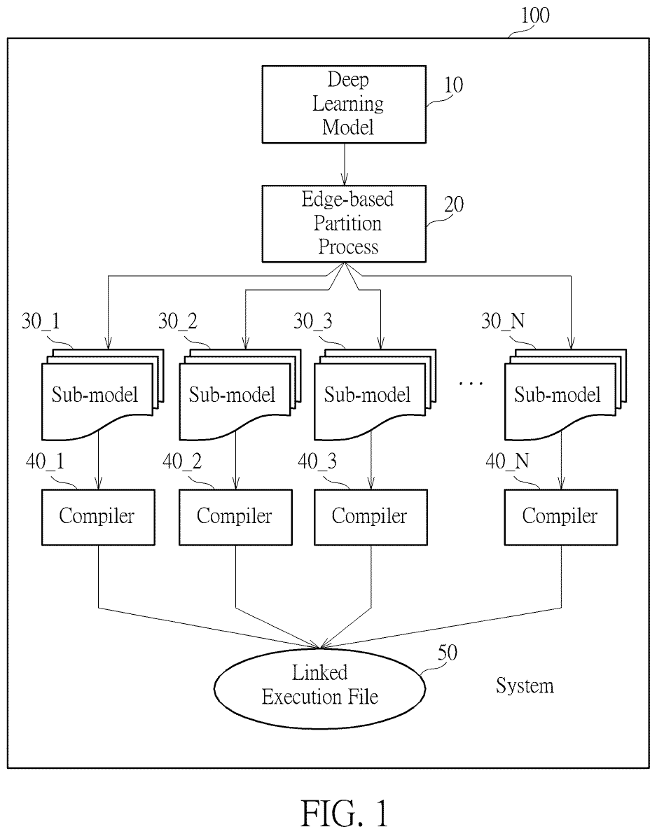

Please refer to FIG. 1, which illustrates a schematic diagram of a system for optimizing a deep learning model according to one embodiment of the present invention. As illustrated, a trained deep learning model 10, which may comprise complex neural network architecture with multiple interconnected layers, is processed by a system 100. The system 100 is configured to execute an edge-based partition process 20 to analyze a computational graph representation of the deep learning model 10, identifying critical edges and potential partition points based on predefined criteria, such as memory traffic costs and operational complexity.

Consequently, the system 100 generates a plurality of sub-models 30_1-30_N corresponding to distinct portions of the deep learning model 10. The sub-models 30_1-30_N are delineated by boundaries determined through the edge-based partition process 20, ensuring optimal partitioning for parallel processing and efficient memory utilization. The system 100 also implements a plurality of compilers 40_1-40_N, which may be identical or specialized for different architectural components. The compilers 40_1-40_N are utilized to separately perform compilation operations on the respective sub-models 30_1-30_N. Such separate/parallel compilation process generates a corresponding plurality of compilation results. Subsequently, the system 100 generates a linked execution file 50 of the deep learning model 10 based on the plurality of compilation results. The linking process integrates the individually compiled sub-models into a cohesive executable unit, preserving overall functionality of the original deep learning model 10 while capitalizing on the compilation efficiency achieved through model partitioning and parallel compilation.

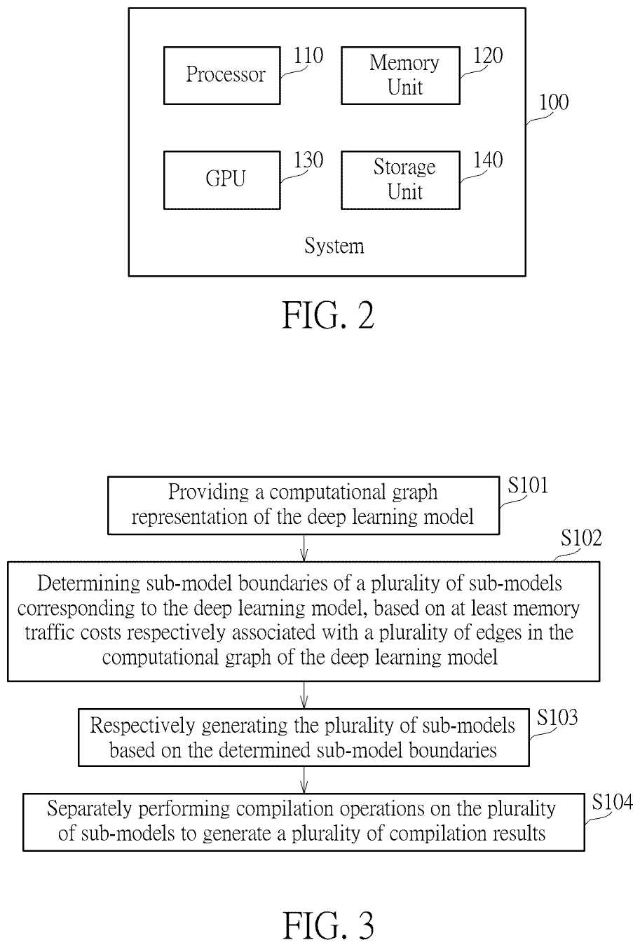

In some embodiments, the system 100 can be implemented through a variety of hardware and software configurations, tailored to meet demands and requirements of deep learning model optimization and compilation. As shown by FIG. 2, the system 100 typically comprises at least one processor 110 and one or more memory units 120. The processor could be a high-performance multi-core CPU, capable of handling the complex computations required for graph analysis and model partitioning. Alternatively, for specialized deep learning tasks, the system 100 might employ application-specific integrated circuits (ASICs), or field-programmable gate arrays (FPGAs) designed specifically for neural network operations. In some embodiments, the system 100 could leverage graphics processing units (GPUs) 130, which excel at parallel processing tasks common in deep learning workloads. Memory subsystem of system 100 might include a hierarchy of storage options: fast, on-chip static random access memory (SRAM) for immediate data access; high bandwidth memory (HBM) for large, high-speed data transfers often crucial in deep learning applications; and larger capacity dynamic random access memory (DRAM) for storing extensive model parameters and intermediate results. In advanced configurations, the system 100 might also incorporate a storage unit 140, such as non-volatile memory express (NVMe) solid-state drives for rapid storage and retrieval of large model files and datasets. The synergy between advanced hardware and specialized software enables system 100 to efficiently handle the complex tasks of model partitioning, optimization, and compilation, ultimately producing high-performance executable models tailored for deployment across various computing platforms.

Please refer to FIG. 3, which illustrates a flow chart of a method for optimizing a deep learning model according to one embodiment of the present invention. At step S101, a computational graph representation of the deep learning model is provided. The computational graph representation serves as a comprehensive abstraction of architecture of the deep learning model, where the computational graph representation typically comprises nodes that represent layers (e.g., convolutional layers, fully connected layers, pooling layers, or normalization layers) and operations (e.g., matrix multiplication operations, activation function operations, scalar multiplication, or data reshaping operations) within the deep learning model. The computational graph representation also comprises edges that represent data flow paths between nodes, thereby capturing interdependencies and computational sequence within the deep learning model.

At step S102, sub-model boundaries of a plurality of sub-models corresponding to the deep learning model are determined. This determination is based on at least memory traffic costs respectively associated with a plurality of edges in the computational graph representation of the deep learning model. Specifically, the memory traffic cost associated with a respective edge indicates an amount of data movement required between computational nodes, which often involve data access operations to memory devices. This cost metric is intended to quantify the memory utilization associated with data movement. By focusing on this metric, the method aims to optimize the overall efficiency of model compilation.

In some embodiments, the memory traffic cost is calculated based on a product of a tensor size associated with the edge and the memory footprint of the data (precision) type used for the edge. Specifically, the tensor size refers to the total number of elements in the tensor, while the memory footprint of the data type represents the amount of memory required to store each element of the tensor, which depends on the specific data type used. For example, if the tensor uses a float32 data type, each element would require 4 bytes of memory. Thus, the memory traffic cost would be calculated as follows: memory traffic cost=tensor size*bytes per element. In the case of float32, this would be: memory traffic cost=tensor size*4 bytes. This calculation provides a precise measure of costs of data movement associated with each edge in the computational graph representation of the deep learning model.

In some embodiments, at step S102, a sub-model boundary exploration process is iteratively performed to determine the sub-model boundaries. This iterative sub-model boundary exploration process comprises: 1) collecting one or more edges from the plurality of edges in the computational graph representation; 2) calculating a memory traffic cost associated with each of the one or more collected edges; 3) identifying a starting point for the sub-model boundary exploration based on an edge with the maximum memory traffic cost; 4) determining a potential sub-model scope originating from the starting point to produce the sub-model boundaries for defining a plurality of candidate sub-models. The potential sub-model scope is a candidate region in the computational graph for optimized compilation and memory access patterns, and serves as a basis for partitioning. The potential sub-model scope can be determined by expanding to incorporate neighboring layers and operations. The sub-model boundary exploration process aims to maximize the potential for efficient compilation of each sub-model.

Identifying the starting point for sub-model boundary exploration based on the edge with maximum memory traffic cost is a critical optimization technique. This approach ensures that high-volume data movements are contained within the same sub-model, rather than occurring between different sub-models. Specifically, this approach is designed to maximize the utilization of faster, lower-latency memory resources such as cache memory or high-hierarchy memory subsystems within a target hardware platform (e.g., the system 100 on which the compilers 40_1-40_N are executed). By localizing intense data movements within a single sub-model, the method increases the probability of data reuse and reduces the frequency of accesses to slower, higher-latency memory types like dynamic random access memory (DRAM). As such, this approach can significantly enhance efficiency of subsequent compilation.

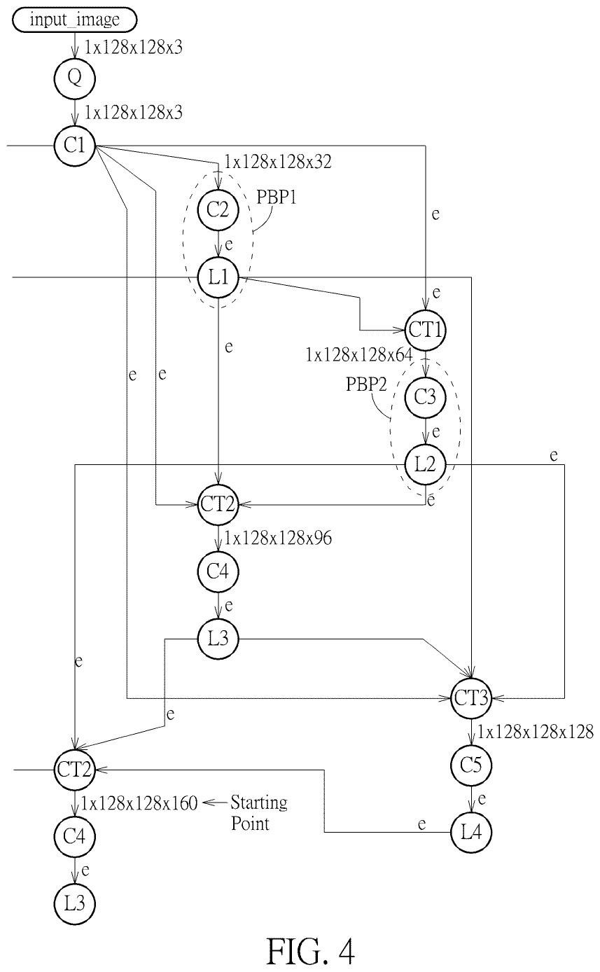

Please refer to FIG. 4, which illustrates FIG. 4 illustrates a portion of a computational graph of a deep learning model for image processing. As illustrated, a circle labeled as “Q” represents a quantize operation, circles labeled as “C1”, “C2”, “C3”, “C4”, “C5” and “C6” represent convolution layers (Conv2D), circles labeled as “L1”, “L2”, “L3”, “L4” and “L5” represent activation operations, namely leaky rectified linear unit (LeakyReLU), and circles labeled as “CT1”, “CT2”, “CT3” and “CT4” represent concatenation operations. Additionally, unidirectional arrows between circles represent edges (i.e., data flow paths) between layers and operations, wherein each arrow is labeled with a tensor size (in the form of “a”×“b”×“c”×“d”) associated with the corresponding edge. For simplicity, some edges with tensor size of “1×128×128×32” is labeled as “e”. Regarding this portion of the deep learning model, the arrow labeled with “1×128×128×160” representing an edge with a tensor size of “1×128×128×160” has the maximum memory traffic cost. Thus, this edge is identified as a starting point for sub-model boundary exploration.

Referring back to step S102, in some embodiments, a pre-processing step may be performed before the iterative sub-model boundary exploration process. The pre-processing is crucial for optimizing the partitioning process and ensuring that certain critical structures within the deep learning model remain intact. Specifically, the pre-processing may comprise: 1) determining one or more pre-bound patterns including multiple specific layers and/or operations of the deep learning model, wherein each of the one or more pre-bound patterns is one of predetermined combinations of specific layers and/or operations in the deep learning models; and 2) incorporating each of the one or more pre-bound patterns into a respective candidate sub-model defined by the sub-model boundaries without splitting the pre-bound pattern across the sub-model boundaries. Specifically, each pre-bound pattern is a set of predetermined combinations of specific layers and/or operations known to be optimally processed together. The grouping of different layers and/or operations to form pre-bound patterns is based on predetermined rules and heuristics for optimization of known structural motifs in deep learning models. Moreover, incorporating each of the one or more pre-bound patterns without splitting it across the sub-model boundaries is intended to preserve optimized compilation of such structures.

To illustrate this concept, please refer to FIG. 4. As shown, convolution layers CONV2D (i.e., circles C2 and C3) can be respectively grouped with activation operations LeakyReLU (i.e., circles L1 and L2) to form pre-bound patterns PBP1 and PBP2. This example demonstrates how commonly associated operations in deep learning models can be pre-bound to ensure they remain together during the edge-based partition process. It is important to note that the combination of the convolution layer CONV2D and activation operation leakyReLU is just one example of a pre-bound pattern. According to various embodiments of the present invention, there could be numerous other operations and/or layers that can be grouped to form pre-bound patterns. These combinations are determined based on their frequency of occurrence in deep learning models, their computational characteristics, and their potential for optimized compilation processing when kept together.

Referring back to step S102, the sub-model boundary exploration process is iteratively performed to determine the sub-model boundaries, guided primarily by a cyclic edge verification process and a maximum operator count constraint. This approach ensures the creation of sub-models that are both structurally sound and computationally balanced. In the cyclic edge verification process, sub-model boundaries are verified and adjusted to ensure no cyclic dependencies exist within each candidate sub-model defined by the sub-model boundaries, thereby maintaining an acyclic structure crucial for efficient compilation optimization. Specifically, candidate sub-models represent potential partitions of the original deep learning model that can be further converted into the sub-models. The acyclic structure prevents infinite loops and ensures a clear, unidirectional flow of data and computations within each candidate sub-model.

Moreover, the sub-model boundary exploration process also employs a maximum operator count constraint, where sub-model boundaries are verified and adjusted based on based on an operator count of each of the plurality of candidate sub-models defined by the sub-model boundaries and a predetermined maximum operator count. The operator count, representing a quantitative measure of computational operations included in a corresponding candidate sub-model, may be calculated using a method to balance computational load across sub-models. The calculation of the operator count may include a complexity-aware scoring system assigning different scores to layers and operations based on their number of operators or computational demands. By employing the operator count calculation, the sub-model boundary exploration process makes decisions about boundary placement, ensuring a balance between complexity of different sub-models. In addition, the predetermined maximum operator count is influenced by the capabilities of the compilers (e.g., compilers 40_1-40_N) and the limitations of the hardware on which these compilers operate.

To illustrate the operator count concept and its impact on sub-model boundary determination, consider an example illustrated by FIG. 4. Assume a scenario where the predetermined maximum operator count is set to 300 (a number chosen for illustrative purposes, which may vary based on specific compiler and hardware constraints) and a total number of operator counts of convolution layers C1-C5, and activation operations L1-L4 and concatenation operations CT 1-CT4 is 280. In this case, convolution layers C1-C5, and activation operations L1-L4 and concatenation operations CT1-CT4 can be incorporated into a same sub-model by placing sub-model boundaries surrounding the above-mentioned layers and operations. However, if the total number of operator counts of convolution layers C1-C5, and activation operations L1-L4 and concatenation operations CT1-CT4 exceeds the predetermined maximum operator count of 300, not all of the convolution layers C1-C5, and activation operations L1-L4 and concatenation operations CT1-CT3 can be incorporated into a same sub-model. This splitting ensures each sub-model remains within computational bounds efficiently handled by the target compiler and hardware.

Recognizing the need for flexibility in real-world scenarios, the method incorporates a degree of tolerance in applying the maximum operator count constraint. In some embodiments, the operator count of a candidate sub-model is allowed to slightly exceed or be limited below the predetermined maximum operator count within a predetermined tolerance range. For example, this tolerance might be up to ±10% (or another suitable percentage range based on system characteristics). This tolerance mechanism serves multiple purposes: it preserves closely related operations that might otherwise be inefficiently partitioned, allows for more compact sub-models when beneficial, and crucially, helps avoid pushing the compiler to its operational limits. By preventing the compiler from operating at its extreme capacity, this approach reduces the risk of compilation failures that could occur when the compiler is overwhelmed by excessively complex sub-models. The sub-model boundaries can thus be determined to allow the operator count of a candidate sub-model to deviate from the predetermined maximum operator count within this predetermined tolerance range, either above or below the limit, ensuring both flexibility and stability in the compilation process.

At step S102, the sub-model boundary exploration process is iteratively performed until all edges in the computational graph representation of the deep learning model have been thoroughly examined and processed. Once all the edges have been visited and evaluated, the determined sub-model boundaries could define candidate sub-models for potential partition. Specifically, these candidate sub-models can either directly serve as the final sub-models or undergo further adjustment through a post-processing step before being finalized as sub-models.

In some embodiments, the post-processing may be performed based on operator counts of the candidate sub-models defined by the sub-model boundary exploration process. The post-processing is designed to further optimize the partitioning of the deep learning model, with a particular focus on maximizing the utilization of compiler capabilities. Specifically, the post-processing may comprise: 1) identifying a specific candidate sub-model having an operator count below a predetermined threshold; 2) selecting another candidate sub-model adjacent to the specific candidate sub-model; and 3) merging the specific candidate sub-model with the selected adjacent candidate sub-model to form a merged sub-model. Importantly, the merging of candidate sub-models is still performed based on the maximum operator count constraint, ensuring that the merged sub-models align well with the capabilities of the compilers. The post-processing serves as a refinement phase, focusing on the consolidation of smaller model partitions that may have been overlooked or sub-optimally processed during the sub-model boundary exploration.

Referring back to FIG. 2, once the sub-model boundaries have been determined at step S102 (either directly from the boundary exploration process or after undergoing the post-processing phase), the method progresses to step S103, where the plurality of sub-models are respectively generated based on the determined sub-model boundaries. Subsequently, at step S104, compilation operations are separately performed on each of the plurality of sub-models to generate a corresponding plurality of compilation results. During this compilation process, optimized codes for each sub-model are generated, meticulously tailored to the specifications of the target hardware. By compiling smaller, well-defined sub-models rather than the entire large-scale model, the overall compilation process can be significantly accelerated. Separate compilation allows for parallel processing of sub-models, potentially reducing the overall time required for changes or updates in auto-tuning phase of the model.

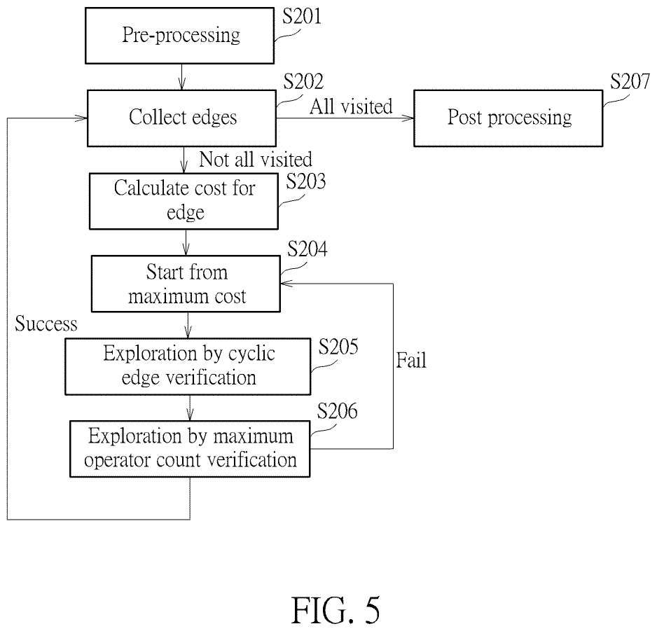

For comprehensive understandings on the edge-based partition process of the present invention, please refer to FIG. 5, which illustrates an edge-based partition process according to one embodiment of the present invention. At step S201, a pre-processing is performed for pre-bound patterns, determining specific layer/operation combinations, such as the convolution layer CONV2D and the activation operation leakyReLU, to ensure the specific layer/operation combinations remain within the same sub-model without being split by the sub-model boundaries during partitioning. At step S202, edges are collected, wherein information (e.g., source and destination nodes or data dimensions) of one or more edges in the computational graph representation of the deep learning model is collected for evaluation. If not all the edges are visited, the flow proceeds to step S203. At step S203, the memory traffic cost for each collected edge is calculated based on a product of a tensor size associated with the edge and the memory footprint of a data (precision) type used for the edge.

At step S204, a sub-model boundary exploration process is initiated from an edge with the maximum memory traffic cost. At step S205, sub-model boundaries are verified and adjusted by a cyclic edge verification process, ensuring no cyclic dependencies exist within each of the candidate sub-models defined by the sub-model boundaries. At step S206, the sub-model boundaries are further verified and adjusted based on a maximum operator count constraint, ensuring each of the candidate sub-models defined by the sub-model boundaries remains within the computational capabilities of the compilers and can be compiled efficiently. As a result, the creation of over-complex candidate sub-models that could lead to compilation failures is prevented.

If the verification at step S206 fails, the flow returns to step S204, where the sub-model boundary exploration process is initiated from another edge (from the collected edges) with the next highest memory traffic cost. On the other hand, if the verification at step S206 succeeds, the flow returns to step S202, where one or more non-visited edges will be collected for evaluation and for performing subsequent sub-model boundary exploration process.

If all the edges within the computational graph representation of the original deep learning model are visited, the flow proceeds to an optional step S207. At step S207, a post-processing may be performed based on operator counts of the candidate sub-models defined by the sub-model boundary exploration process. The post-processing is designed to further optimize the partitioning of the original deep learning model, with a particular focus on maximizing the utilization of compiler capabilities. Specifically, during the post-processing, sub-model boundaries may be further verified and adjusted by merging a specific candidate sub-model with low operator count (e.g., below a predetermined threshold) into another adjacent candidate sub-model, while still complying with the maximum operator count constraint. After step S207, the final determined sub-model boundaries are used to perform partitioning on the original deep learning model, resulting in partitioned sub-models for subsequent compilation.

Please note that the term “sub-model” may refer to a partition of original deep learning model that has undergone the sub-model boundary exploration process only or both the sub-model boundary exploration process and post-processing optimization and represents an optimized unit for compilation.

In conclusion, the present invention represents a significant leap forward in optimization of large-scale deep learning models. By intelligently partitioning models based on memory traffic costs and compiler capabilities, it addresses two critical challenges: extended compilation times and inefficient memory utilization. The innovative approach substantially reduces compilation times from weeks to mere days or hours, while simultaneously improving model execution efficiency, particularly in memory-constrained environments. The method's adaptability to various model architectures and hardware configurations enhances scalability, enabling effective deployment across a spectrum of computing platforms, from high-performance servers to edge devices. Furthermore, the potential for parallel compilation and optimization of sub-models accelerates the development and deployment process, making advanced AI models more accessible and practical for a wider range of applications. As the field of artificial intelligence evolves towards increasingly complex models, the present invention provides a crucial tool for managing growing computational demands and fostering innovation.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for optimizing a deep learning model, comprising:
providing a computational graph representation of the deep learning model;
determining sub-model boundaries of a plurality of sub-models corresponding to the deep learning model, based on at least memory traffic costs respectively associated with a plurality of edges in the computational graph of the deep learning model;
respectively generating the plurality of sub-models based on the determined sub-model boundaries; and
separately performing compilation operations on the plurality of sub-models to generate a plurality of compilation results.

2. The method of claim 1, further comprising:
generating a linked execution file of the deep learning model based on the plurality of compilation result.

3. The method of claim 1, wherein the step of determining the sub-model boundaries of the plurality of sub-models comprises:
iteratively performing a sub-model boundary exploration process, comprising:
collecting one or more edges from the plurality of edges;
calculating a memory traffic cost associated with each of the one or more collected edges;
identifying a starting point for the sub-model boundary exploration based on a collected edge with a maximum memory traffic cost; and
determining a potential sub-model scope originating from the starting point to produce the sub-model boundaries for defining a plurality of candidate sub-models.

4. The method of claim 3, wherein the memory traffic cost associated with a respective edge indicates an amount of data movement regarding a data access operation to a memory device for the edge and is calculated based on a product of a tensor size associated with the edge and a memory footprint of a data type associated with the edge.

5. The method of claim 3, wherein step of determining the sub-model boundaries of the plurality of sub-models further comprises:
determining one or more pre-bound patterns including multiple specific layers and/or operations of the deep learning model, wherein each of the one or more pre-bound patterns is one of predetermined combinations of specific layers and/or operations in the deep learning models; and
incorporating each of the one or more pre-bound patterns into a respective candidate sub-model defined by the sub-model boundaries without splitting the pre-bound pattern across the sub-model boundaries.

6. The method of claim 3, wherein step of iteratively performing the sub-model boundary exploration process further comprises:
determining the sub-model boundaries based on a cyclic edge verification process; and
determining the sub-model boundaries based on a maximum operator count.

7. The method of claim 6, wherein step of determining the sub-model boundaries based on the cyclic edge verification process comprises:
verifying and adjusting the sub-model boundaries to ensure no cyclic dependencies exist within each of the plurality of candidate sub-models defined by the sub-model boundaries.

8. The method of claim 6, wherein step of determining the sub-model boundaries based on the maximum operator count constraint comprises:
verifying and adjusting the sub-model boundaries based on an operator count of each of the plurality of candidate sub-models defined by the sub-model boundaries and a predetermined maximum operator count, wherein the operator count represents a quantitative measure of computational operations included in a corresponding candidate sub-model.

9. The method of claim 3, further comprising:
after iteratively performing the sub-model boundary exploration process, verifying and adjusting the sub-model boundaries by:
identifying a specific candidate sub-model having an operator count below a predetermined threshold;
selecting another candidate sub-model adjacent to the specific candidate sub-model; and
merging the specific candidate sub-model with the selected adjacent candidate sub-model to form a merged sub-model.

10. A system for optimizing deep learning models, comprising:
a processor; and
a memory storing instructions that, when executed by the processor, cause the system to perform operations comprising:
providing a computational graph representation of the deep learning model;
determining sub-model boundaries of a plurality of sub-models corresponding to the deep learning model, based on at least memory traffic costs respectively associated with a plurality of edges in the computational graph of the deep learning model;
respectively generating the plurality of sub-models based on the determined sub-model boundaries; and
separately performing compilation operations on the plurality of sub-models to generate a plurality of compilation results.

11. The system of claim 10, wherein when the instructions are executed by the processor, the system is caused to perform operation of:
generating a linked execution file of the deep learning model based on the plurality of compilation result.

12. The system of claim 10, wherein when the instructions are executed by the processor, the system is caused to perform operation of:
iteratively performing a sub-model boundary exploration process, comprising:
collecting one or more edges from the plurality of edges;
calculating a memory traffic cost associated with each of the one or more collected edges;
identifying a starting point for the sub-model boundary exploration based on a collected edge with a maximum memory traffic cost; and
determining a potential sub-model scope originating from the starting point to produce the sub-model boundaries for defining a plurality of candidate sub-models.

13. The system of claim 12, wherein the memory traffic cost associated with a respective edge of the one or more collected edges indicates an amount of data movement regarding a data access operation to a memory device for the edge and is calculated based on a product of a tensor size associated with the edge and a memory footprint of a data type associated with the edge.

14. The system of claim 12, wherein when the instructions are executed by the processor, the system is caused to perform operation of:
determining one or more pre-bound patterns including multiple specific layers and/or operations of the deep learning model, wherein each of the one or more pre-bound patterns is one of predetermined combinations of specific operations in the deep learning models; and
incorporating each of the one or more pre-bound patterns into a respective candidate sub-model defined by the sub-model boundaries without splitting the pre-bound pattern across the sub-model boundaries.

15. The system of claim 12, wherein when the instructions are executed by the processor, the system is caused to perform operation of:
determining the sub-model boundaries based on a cyclic edge verification process; and
determining the sub-model boundaries based on a maximum operator count.

16. The system of claim 15, wherein when the instructions are executed by the processor, the system is caused to perform operation of:
verifying and adjusting the sub-model boundaries to ensure no cyclic dependencies exist within each of the plurality of candidate sub-models defined by the sub-model boundaries.

17. The system of claim 15, wherein when the instructions are executed by the processor, the system is caused to perform operation of:
verifying and adjusting the sub-model boundaries based on an operator count of each of the plurality of candidate sub-models defined by the sub-model boundaries and a predetermined maximum operator count, wherein the operator count represents a quantitative measure of computational operations included in a corresponding candidate sub-model.

18. The system of claim 12, wherein when the instructions are executed by the processor, the system is caused to perform operation of:
after iteratively performing the sub-model boundary exploration process, verifying and adjusting the sub-model boundaries by:
identifying a specific candidate sub-model having an operator count below a predetermined threshold;
selecting another candidate sub-model adjacent to the specific candidate sub-model; and
merging the specific candidate sub-model with the selected adjacent candidate sub-model to form a merged sub-model.

19. A non-transitory computer-readable storage medium storing instructions that, when executed by a processor, cause the processor to perform operations of:
providing a computational graph representation of the deep learning model;
determining sub-model boundaries of a plurality of sub-models corresponding to the deep learning model, based on at least memory traffic costs respectively associated with a plurality of edges in the computational graph of the deep learning model;
respectively generating the plurality of sub-models based on the determined sub-model boundaries; and
separately performing compilation operations on the plurality of sub-models to generate a plurality of compilation results.
